(19) United States
(12) Patent Application Publication
(10) Pub. No.: US 2022/0198389 A1
(43) Pub. Date: Jun. 23, 2022

(54) Reconfigurable Decentralized Freight Shipping system and Method of Operation Thereof

(71) Applicant: Mintron Energy Technology Co., Ltd., Taoyuan City (TW)

(72) Inventors: Chia-Ming Chuang, Taoyuan City (TW); Chen-Sheng Huang, Taoyuan City (TW)

(73) Assignee: Mintron Energy Technology Co., Ltd.

(21) Appl. No.: 17/247,811

(22) Filed: Dec. 23, 2020

(51) Int. Cl. G06Q 10/08; H04L 29/08; G06Q 10/06; B65G 63/00; G05D 1/02

(52) U.S. Cl. CPC G06Q 10/0838; H04L 67/12; G06Q 10/087; G06Q 10/06312; B65G 2201/0235; G05D 1/0225; G06Q 10/08355; B65G 2203/0208; B65G 63/004

(57) ABSTRACT

Disclosed is reconfigurable decentralized freight shipping system, configured for a shipper to send at least one shipment to a predetermined target, including: at least one freight terminal configured for receiving a plurality of shipment-loaded standard sized modular container; a plurality of transport means respectively having a wireless communication means and operating in respective operating areas, each of the operating areas being at least intersected with at least another one of the operating areas, and at least one computing server configured for computing the shipping information and the location information of the wireless communication means to work out a delivery solution, transmitting delivery information corresponding to the delivery solution to the transport means, and updating the delivery solution based on the updated shipping information changed by the shipper and/or the recipient destination.

### FIELD

Embodiments of the present disclosure relate to a reconfigurable decentralized freight shipping system and a method of operation thereof, and more particularly relate to a freight shipping system used for real-time updating freight shipping information and a method of operation thereof.

### BACKGROUND

For logistics shipping, a core issue lies in how to enhance freight shipping efficiency to thereby reduce expenses or promote profits. To achieve that, a large logistics service provider generally chooses an inexpensive location in a large geographical territory to establish a freight hub. This large geographical territory is then further partitioned into a plurality of cells; each cell is equipped with dedicated trucks and other forms of small transport means, which are responsible for, within their respective cells, delivering shipments to recipients and collecting shipper's carriages for shipping to designated destinations. The trucks and even the small transport means carry those interregional shipments to the freight hub at regular time, where such shipments are pooled, sorted, and then dispatched to corresponding trucks or small transport means to carry back to their respective responsible cells and deliver to the recipients.

Those countries with flourishing industry and commerce have a huge daily throughput of interregional or international freights, such that an international airport has to separately plan a freight terminal in the airport territory for freighters to take off or land to load and offload cargos at nights, or even invests on a freight airport. Some large international logistics service providers even establish dedicated airports in one or more countries and own dedicated freighter fleets, for inter-regionally or internationally shipping the goods consigned by clients. Time scheduling matters much to this centralized logistics mode. A client must contact the logistics service provider first to agree on the time for sending or receiving a shipment. The main shipping links, including shipment gathering and re-dispatching, are all performed at fixed time frames to enhance transit efficiency.

However, this centralized logistics process inevitably requires establishment of a freight hub in a remote area, as well as provision of efficient sorting facilities. Planning of such a hub not only requires a heavy investment on construction, but also wastes time for the transport vehicles compulsorily shuttling between their respective cells and the hub; fast sorting of the inbound freights and dispatching them to different destinations are all done in a tight and fixed time window; under the stress of so short a time window, misidentification, collision or inadvertent falloff during handling frequently occur, and mistaken sorting of or damages to shipments are not uncommon during shipping.

This shipping mode with a single parcel as a shipping unit requires repeated identification work during transit, which also causes progressive increase of errors in automatic identification. Besides, as the parcels possibly do not have standard sizes or are not placed on definite locations, an identification error or failure further requires manual troubleshooting, which further increases troubleshooting costs. In addition, despite the efficient shipping of logistics service providers, it frequently occurs in the last link that the recipient is not available or the recipient address is mistranslated, which wastes the precious time of courier to re-deliver, or postpones delivery; and from the shipper's perspective, his or her business opportunity might be missed if the shipment is delayed due to some reason.

A typical logistics system involves transport vehicles such as different sizes of trucks and aircrafts during parcel shipping. Each time of parcel offloading and relocating would cause, inter alia, mutual crushing, falloff, or missing. Manual handling of the shipments is inevitable, which not only consumes manpower costs but also affects delivery time due to work hour limits of workers, but also incurs liabilities such as artificial damages to the shipments, delivery to a wrong address, and vehicle accidents on road, etc. The biggest problem is that the conventional logistics system takes the designated address as the shipping destination, and there is no way to access the accurate position of a shipment in a certain truck during transit; in cases where the destination is changed, the shipment has to be found out from a pile of shipments and then identified; therefore, for conventional express logistics, after the parcel has been picked up, the designated destination cannot be changed. Whether to redeliver another day or send the parcel back to the shipper can only be decided on upon delivery failure.

On the other hand, a typical logistics system usually takes the address written by the shipper as the designated destination, and it is hard to immediately identify whether the address is valid or correct when picking up the shipment. In cases where the shipment involves international shipping or different shipping channels, change or translation of destination address easily incurs errors. It is also a challenge to the delivery driver's familiarity with the local area in cases of using an address as the destination, which easily causes delay or failure to access the address.

Therefore, the following problems need to be resolved in the field: how to improve the logistics process such that the recipient and the shipper can receive or send a shipment at any convenient time, thereby improving pickup/delivery friendliness; how to eliminate the need of establishing a large freight hub to reduce costs, and avoid forcibly fast sorting in a particular short time window so as to lower the odds of violently handling the parcels and then reduce misidentification and damages; how to enable the pickup and delivery personnel to effectively pick up and deliver the shipments so as to mitigate unnecessary manpower waste in redelivery; and how to enable change of the destination address or recipient in real time so as to offer a shipping flexibility.

### SUMMARY

To address the above deficiencies, embodiments of the present disclosure provide a reconfigurable decentralized freight shipping system, so as to: (1) eliminate the need of establishing a conventional freight hub, thereby significantly reducing operating costs; (2) avoid the time wasted in sending the shipments to a hub for sorting, thereby improving delivery efficiency; (3) avoid the urgency in sending the shipments to the hub for sorting, thereby reducing sorting errors.

Embodiments of the present disclosure further provide a reconfigurable decentralized freight shipping method, so as to: (1) update shipment delivery information in real time, thereby enabling dynamic adjustment of a delivery solution for a standard sized freight modular container, and thereby enhancing efficiency of the whole freight shipping process and reducing time overheads incurred by delivery failure; (2) enable real-time sorting during the freight shipping process by leveraging a freight terminal and an unmanned handling unit to pick up and deliver shipments, which eliminates the need of specifically taking time for collective sorting, thereby reducing errors due to the urgency in sorting and delivery; (3) enable accurate deposit, pickup, and transshipping of a shipment by accurately accessing real-time location and destination address of the shipment whenever necessary, and allow for changing the shipping information, thereby enhancing shipping flexibility.

According to embodiments, a reconfigurable decentralized freight shipping system is provided, configured for a shipper to send at least one shipment to a predetermined target, the shipment being pre-packed into a standard sized modular container, the standard sized modular container being selected from a plurality of preset sizes, and the shipper pre-inputting shipping information including shipment information and predetermined target information to the decentralized freight shipping system, wherein when the shipper and/or the predetermined target modifies the shipping information to updated shipping information, delivery is modified in real time; wherein the decentralized freight shipping system comprises: at least one freight terminal, including at least one first storing unit configured for storing the standard sized modular container with the shipment packed; a plurality of transport means operating in respective operating areas, each of the operating areas being at least intersected with at least another one of the operating areas, each of the transport means including at least one unmanned handling unit, each unmanned handling unit having a plurality of standard slots, the unmanned handling unit being configured for picking up the standard sized modular container with the shipment packed, securely storing the standard sized modular container into one of the standard slots, and recording position of the standard slot; a plurality of wireless communication means respectively installed in the plurality of transport means, the wireless communication means being configured for converting data of the respective unmanned handling units of the plurality of transport means, loaded conditions of the respective standard slots, and position of the standard slot where the standard sized modular container with the shipment packed is stored, into updated payload information to transmit; and at least one server storing transit information regarding the respective operating areas of the transport means and their current locations, the server being configured for receiving the shipping information and the payload information, wherein based on the received shipping information and payload information, the server computes the operating areas traversed for delivering the standard sized modular container with the shipment packed from the freight terminal to work out a delivery solution, and transmits delivery information corresponding to the delivery solution to the transport means, and when receiving the updated shipping information changed by the client and/or the predetermined target, updates the delivery solution in real time.

According to embodiments, a reconfigurable decentralized freight shipping method is provided, configured for a shipper to ship at least one shipment to a predetermined target via a reconfigurable decentralized freight shipping system, the shipment being pre-packed in a standard sized modular container, the standard sized modular container being selected from a plurality of preset sizes, wherein the reconfigurable decentralized freight shipping system comprises: at least one freight terminal; a plurality of transport means operating in respective operating areas; a plurality of wireless communication means respectively installed in the transport means, and at least one server in communicative connection with the wireless communication means; wherein the freight terminal includes at least one storing unit configured for storing the standard sized modular container with the shipment packed; each of the operating areas being at least intersected with at least another one of the operating areas, each of the transport means including at least one unmanned handling unit, each unmanned handling unit having a plurality of standard slots, and the server storing transit information including the respective operating areas of the transport means and their current locations; wherein the reconfigurable decentralized freight shipping method comprises steps of: a) receiving, by the server, shipping information from the shipper, wherein the shipping information includes location of the freight terminal, size of the standard sized modular container, and predetermined target data; and receiving payload information transmitted from the wireless communication means, wherein the payload information includes data regarding the respective unmanned handling units of the plurality of transport means, and loaded conditions of the respective standard slots on the respective unmanned handling units; b) determining, by the server, a delivery solution for the standard sized modular container with the shipment packed based on the shipping information, the transit information, and the payload information; c) transmitting, by the server via the wireless communication means, at least part of the delivery solution as delivery information to the transport means to instruct the transport means to travel to the freight terminal to pick up, via the unmanned handling unit, the standard sized modular container with the shipment packed ; d) securely storing, by the unmanned handling unit, the standard sized modular container with the shipment packed into one of the standard slots, and recording the position of the standard slot; then, transmitting, by the wireless communication means, updated payload information to the server; and e) in cases where the shipper and/or the predetermined target changes the shipping information to updated shipping information, updating in real-time, by the server through computing, the delivery solution based on the updated shipping information, and transmitting updated delivery information corresponding to the updated delivery solution to the transport means.

The reconfigurable decentralized freight shipping system and method of operation thereof as provided by the present disclosure enable a shipper to ship his/her shipment at his/her convenient time, where the shipment is well kept in a standard sized modular container and securely handled by the unmanned handling unit, which guarantees safety and security of the shipment and avoids mistaken delivery, while the decentralized freight shipping method enables a logistics service provider to save the fixed costs of establishing a freight hub and installing a huge number of sorting facilities; furthermore, as the sorting is synchronously performed during operating of the transport means, time waste in freight distribution and the urgency in sorting are completely eliminated, which significantly reduces errors and damages. In addition, the real-time freight shipping system according to the present disclosure enables fast and accurate deposit, pickup and transshipping of the shipments or real-time change of the shipping destination and arrival time, such that the recipient and the shipper can receive and send the shipment in real time, and the shipment pickup personnel and delivery personnel can effectively pick up and deliver the shipment, which significantly enhances efficiency of conventional freight shipping systems and achieves a revolutionary improvement.

### BRIEF DESCRIPTION OF THE DRAWINGS

FIG. 1 is a schematic diagram of operating areas of a decentralized freight shipping system according to a first preferred embodiment of the present disclosure.

FIG. 2 is a stereoscopic schematic diagram of a freight terminal.

FIG. 3 is a schematic perspective top view of the freight terminal of FIG. 2 (illustrating the size and fixation manner of a standard sized modular container).

FIG. 4 is a flow chart of a freight shipping method according to a first preferred embodiment.

FIG. 5 is a schematic side view of a bus according to a first preferred embodiment of the present disclosure.

FIG. 6 is a schematic top view of the bus of FIG. 5 (illustrating the manner of exchanging between the unmanned handling units).

FIG. 7 is a stereoscopic schematic diagram of the unmanned handling unit according to the first preferred embodiment of the present disclosure.

FIG. 8 is a stereoscopic schematic diagram of a freight terminal according to a second preferred embodiment of the present disclosure.

FIG. 9 is a schematic side view of a truck according to a second preferred embodiment of the present disclosure.

FIG. 10 is a schematic top view of the truck of FIG. 9 (illustrating the relationship between the unmanned handling unit and the standard slot shelf in terms of delivery).

Among the drawings: 1. decentralized freight shipping system; 2, 2′. freight terminal; 20, 20′. first storing unit; 3, 3′. transport means; 300′. standard slot; 30, 30′. unmanned handling unit; 320′. closed railway; 32′. second storing unit; 322′. standard slot shelf; 4. server; 5, 5′. wireless communication means; 60. 60′. standard sized modular container; 62, 62′. loaded standard sized modular container; 7′. image capturing device; 81˜89. steps; A, B, C, and D referring to operating areas.

### DETAILED DESCRIPTION OF EMBODIMENTS

Hereinafter, the present disclosure will be illustrated in further detail through preferred embodiments with reference to the accompanying drawings. Such embodiments should be understood as only intended for illustrating the present disclosure, rather than limiting the protection scope thereof After having read the description of the present disclosure, those skilled in the art may make various alterations or modifications to the present disclosure, and such equivalent alterations and modifications also fall within the scope limited in the appended claims.

### First Preferred Embodiment

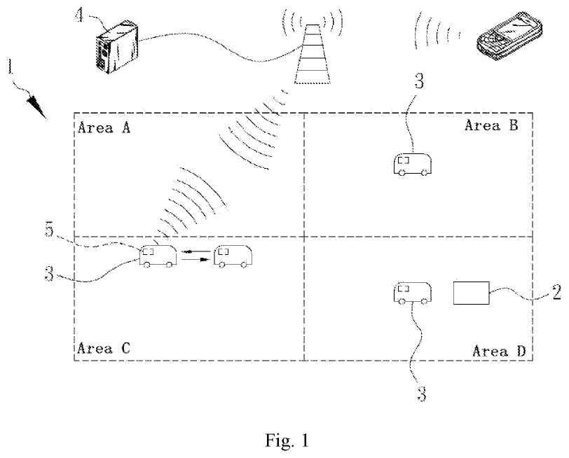

FIG. 1 shows a reconfigurable decentralized freight shipping system 1 provided according to the first preferred embodiment of the present disclosure, which is configured for a shipper to ship at least one shipment to a predetermined target. In this embodiment, a system operator partitions, for example, a service territory of one county/city into operating areas A, B, C, and D, and at least one transport means 3 such as a truck is arranged for each operating area,; each of the transport means 3 operates in their respective operating areas, and each of the operating areas has an intersected zone at least with another neighboring operating area; in this way, one transport means 3 may transship the shipment carried thereby to the transport means 3 in the neighboring operating area; in this way, the logistics service provider delivers, stage by stage, the shipment to the recipient or reception location, without a need of assembling all shipments to a certain hub, thereby realizing the decentralized freight shipping in the sense of the present disclosure.

In this embodiment, the shipper is a member already registered in the system. Before shipping, the shipper is required to prepare an appropriate and empty standard sized modular container with a unique identifier for packing the shipment. In this embodiment, the standard sized modular container is made of a light and impact-resistant material such as ABS engineering plastics. However, the present disclosure is not limited thereto, and in alternative embodiments, the standard sized modular container may also be made of aluminum alloy. The standard sized modular container is provided in a plurality of different standard sizes. In this embodiment, the modular container only has a single preset depth, and its size is selected from a plurality of preset sizes that are simple integer multiples of preset length and width.

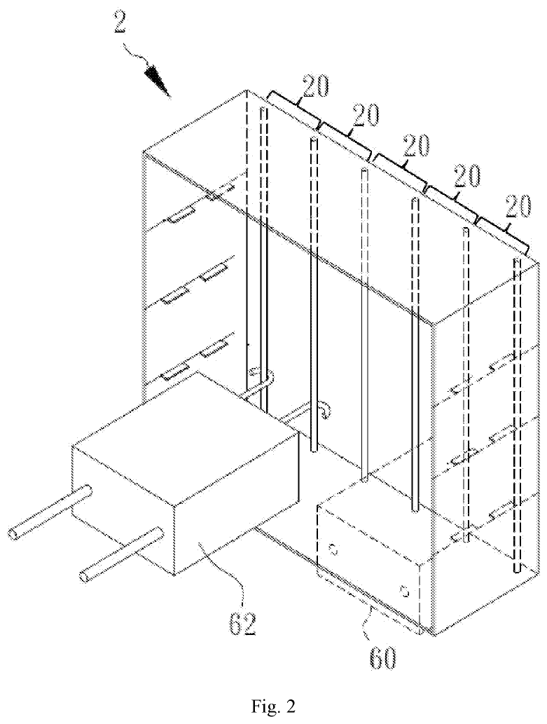

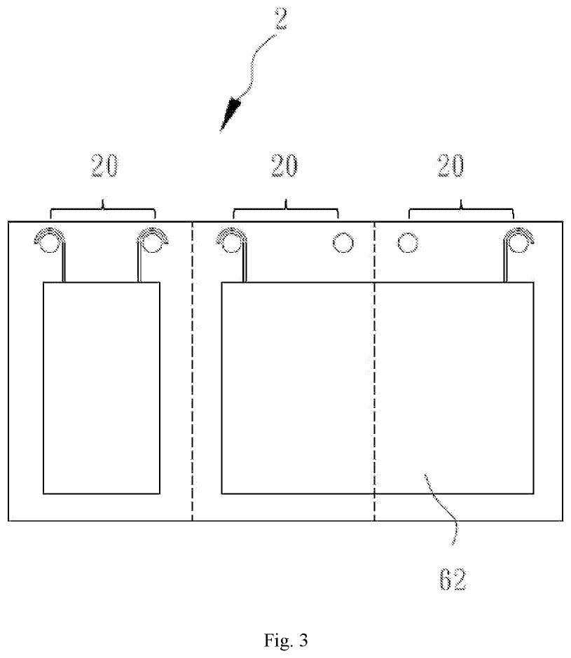

In this embodiment, in conjunction with FIG. 2, the shipper places the shipment in a standard sized modular container 60 in advance. For the ease of illustrating, the standard sized modular container with the shipment packed is referred to as a loaded standard sized modular container 62; the shipper drops off the loaded standard sized modular container 62 to an agreed freight terminal 2, e.g., an unattended parcel locker in the hall of an office building. Please also refer to FIG. 3, in this embodiment, six immobilized columns, for example, are provided in the rear side of the parcel locker, where every two immobilized columns serve as one first storing unit 20; therefore, in this embodiment, three first storing units 20 in total are provided in the parcel locker. As each pair of immobilized columns are spaced and immobilized relative to each other, while the spacing between each pair of immobilized columns and its neighboring pair of immobilized columns has been standardized, if the shipper uses a standard sized modular container of one unit width, the container may be securely stored between one pair of immobilized columns; if the container is of a two-unit width, the container would traverse two pairs of immobilized columns and then be securely stored between the outermost two columns of the four immobilized columns; likewise, if the standard sized modular container has a three-unit width, it is securely stored between the outermost two columns of the six parallel immobilized columns. A same selection flexibility is also provided in the height direction; as such, not only the modular container is standardized, but also an appropriate size is provided for various dimensions of shipments.

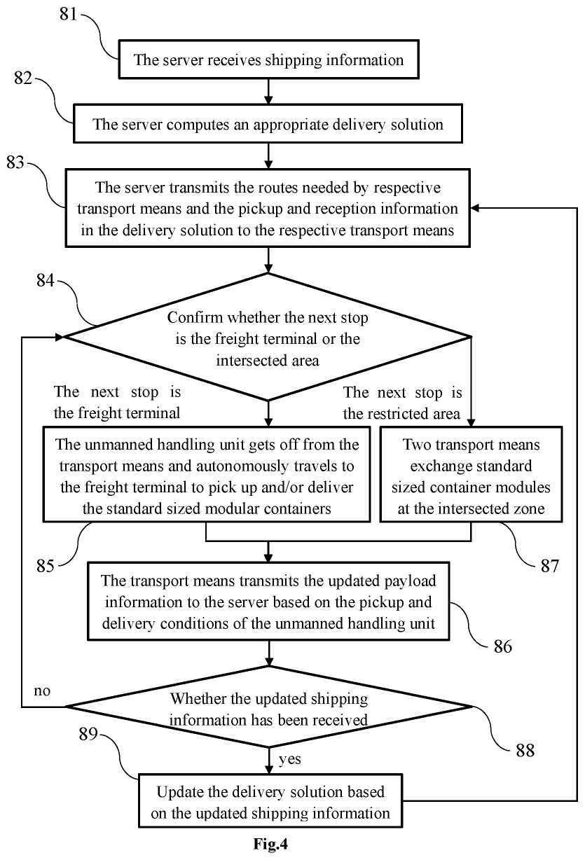

Then, the shipper connects for example his/her own smart phone or computer to the decentralized freight shipping system 1 over the network, to input the unique identifier of the loaded standard sized modular container 62 and the predetermined target as one package of shipping information to a server 4 in the decentralized freight shipping system 1. In this embodiment, the server 4 is a workstation-level computer equipped with a group of network interfaces for receiving and transmitting all relevant information. After the loaded standard sized modular container 62 is properly placed, the shipper photographs or records its deposit position, wherein the picture of the deposit position of the loaded standard sized modular container 62 is also uploaded to the server 4 as part of the shipping information. As shown in FIG. 4, after the server 4 receives all the shipping information in step 81, it quickly computes an appropriate delivery solution in step 82, and then transmits the delivery solution, the route for each transport means 3, and pickup and delivery information to the respective transport means 3 via the network interface.

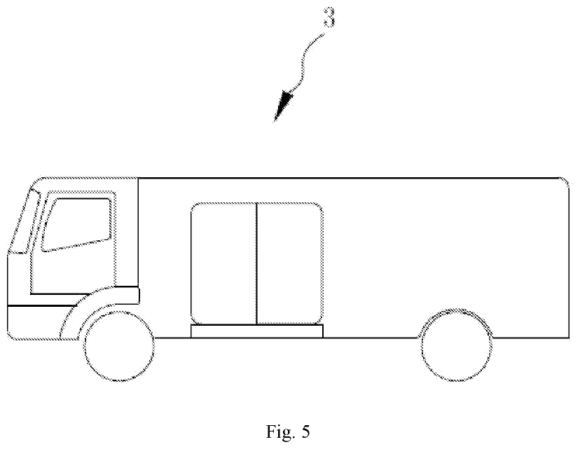

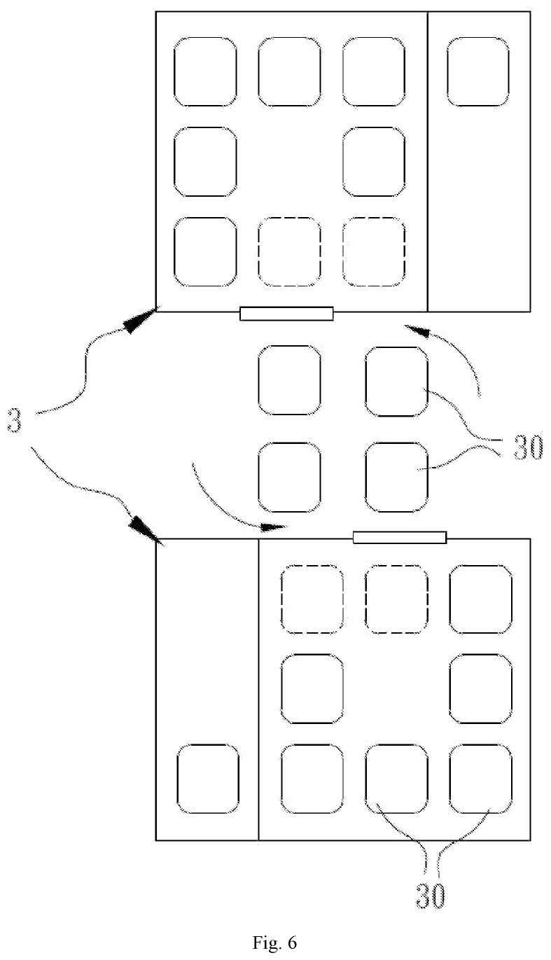

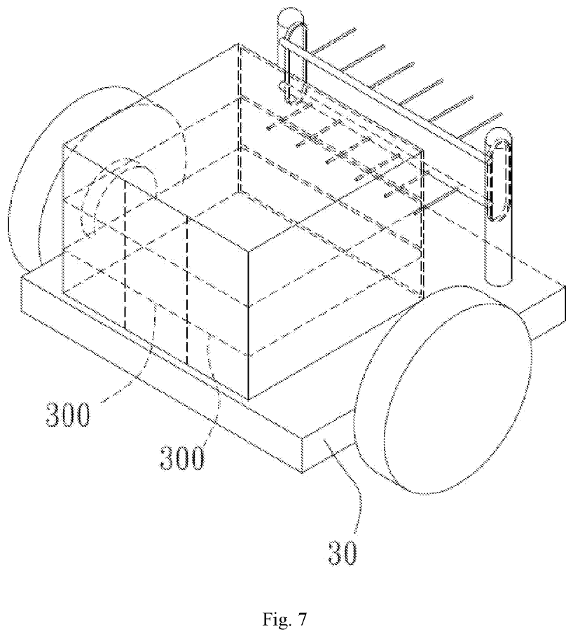

The transport means 3 in this embodiment is illustrated exemplarily as a typical passenger bus shown in FIG. 5 and FIG. 6. At nights when the passenger services are off, the passenger bus is refitted to remove the seats, such that the passenger cabin is emptied to serve as a truck. The passenger cabin can accommodate for example 9 unmanned handling units 30. The unmanned handling unit 30 is shown in FIG. 7, which is illustrated as a dynamic balancing cart. In this embodiment, each unmanned handling unit may carry a standard slot 300 storing a standard sized modular container of three-unit width and three-unit height; in cases where the bus carries eight unmanned handling units 30, a space of one unmanned handling unit 30 is left unoccupied; therefore, in the passenger cabin of the bus, the respective unmanned handling unit 30 may assume a form of smart grid, which may move relatively to achieve an appropriate load capacity. Likewise, in step 81, each bus also transmits the identifiers of respective loaded standard sized modular containers 62 carried on the bus, and information regarding in which standard slot 300 of which unmanned handling unit 30 the modular container is received, to the server 4 as payload information.

Each bus is installed with a 5G wireless communication means 5; as such, when the server 4 computes an updated delivery solution based on the shipping information and the payload information in step 82, the shipment pickup and delivery data with respect to the bus are extracted out from the delivery solution as the delivery information for the bus and then transmitted to the bus via the wireless communication means 5 on the bus in step 83; then, in step 84, the bus is instructed to travel to a parking lot near the freight terminal 2; in step 85, the unmanned handling unit 30 gets off from the lifting platform of the bus, autonomously travels before the freight terminal 2 to take out the loaded standard sized modular container 62 from the deposit position 200 and place it into the standard slot 300 on the dynamic balancing cart, and then takes out a loaded standard sized modular container 62 to be delivered to this operating area from its standard slot 300 and stores and secures it to the freight terminal 2. Of course, as will be easily appreciated by those skilled in the art, the bus planned in this embodiment is an autonomous vehicle, which thus requires extensive information transmission; this is why a 5G network is used as the wireless communication means 5; if the bus is still manipulated by a human driver, the wireless communication means 5 may use a 4G or other similar means, which does not affect implementation of the present disclosure.

As the freight terminal 2 in this embodiment is not equipped with communication and processing means, the unmanned handling unit 30 is illustrated to have a processor and a communicator; in step 86, when the unmanned handling unit 30 returns to the transport means 3, it will transmit the identity two-dimensional bar code of the newly picked-up loaded standard sized modular container 62 and the locker number of the newly picked-up loaded standard sized modular container 62 on itself to the bus. The microcomputer on the bus saves the loaded conditions of respective standard slots 300 of the respective unmanned handling units 30 thereon and the data of all carried standard sized modular containers into a memory unit, for example, a solid-state disk, on the bus. Afterwards, the microcomputer would upload, at regular intervals, the bus payload information to the server 4 via the wireless communication means 5. Therefore, the server 4 and the respective transport means 3 exchange and update all payload information and delivery information at regular intervals.

If the delivery information in step 84 instructs the bus to travel to a location intersected with a neighboring operating area and exchange shipments with another bus in the neighboring operating area, then in this embodiment, one or more dynamic balancing carts in the bus will be assigned to collect all standard sized modular containers on the bus to be transshipped to the neighboring operating area into the standard slots 300 in the one or more dynamic balancing carts. In step 87, the buses from the two neighboring operating areas will meet at the intersected location, and the former one or more dynamic balancing carts, along with the modular containers stored in the standard slots 300, will be transshipped to the bus from the neighboring operating area, while a corresponding number of dynamic balancing carts from the neighboring bus will travel into the current bus to thereby complete payload exchange. Likewise, in step 87, when the exchanged dynamic balancing cart travels into the range of the current bus, the identifier of the dynamic balancing cart and the payload information of the standard slot 300 thereof will be automatically reported and transmitted back to the server 4 in accordance with step 86.

Therefore, each time when a loaded standard sized modular container 62 arrives at the freight terminal 2 at the predetermined target, the server 4 will receive a corresponding payload information update, and then information regarding arrival of the loaded standard sized modular container 62 is transmitted to the predetermined recipient for receipt of the shipment. Particularly, if the recipient changes his/her schedule provisionally, e.g., going to another place for a meeting, and urgently needs for example the sample in the loaded standard sized modular container 62 for presentation, he or she may notify the server 4 of the updated shipping information before the shipment arrives, and then the shipping information is updated in step 88; during operating of the bus, the server 4 will transmit the updated delivery solution in real time to the bus, and the dynamic balancing cart on the bus possibly exchanges the position of the loaded standard sized modular container 62 in the standard slot 300 and delivers the modular container to the freight terminal 2 near the place of meeting based on the new delivery solution, thereby significantly reducing repeated deliveries incurred by delivery failure.

As the server 4 constantly receives all shipping information, the real-time locations of all transport means 3 in their respective operating areas, transit information such as the ongoing traveling routes, and payload information of each transport means 3, and constantly iteratively updates the latest delivery solutions, it can respond in real time to provisional change of shipping data from the shipper or the recipient, such that the real-time freight shipping system and shipping method disclosed by the present disclosure are adapted to sufficiently satisfy fast and flexible demands of the modern society. On the other hand, as the shipping and transshipment are all done by a variety of transport means 3 and unmanned handling units 30 in a decentralized manner, a dedicated freight hub is eliminated, which not only saves investments on the hub, but also avoids waste of time in repeated assembling and dispatching of shipments; particularly, during the shipping process, there is no urgent time pressure involved with a hub and all modular containers may be simultaneously sorted and exchanged while the buses are operating, which reduces errors in the distribution process and lowers the risks of damaging the modular containers incurred by urgent delivery time.

### Second Preferred Embodiment

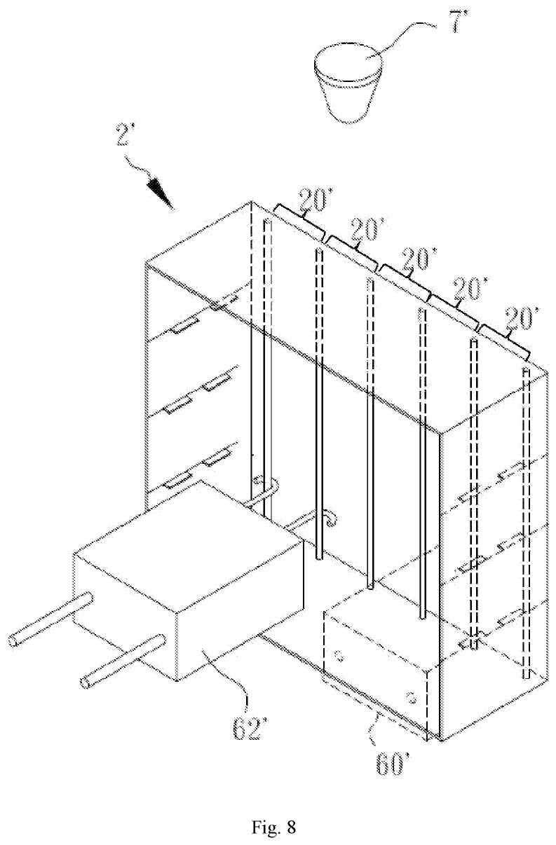

FIG. 8 shows a reconfigurable decentralized freight shipping system according to the second preferred embodiment of the present disclosure, where those parts identical to the first preferred embodiment will not be elaborated, and only those different parts are illustrated. In this embodiment, it is unnecessary for the shipper to prepare an empty standard sized modular container 60′ in advance; instead, a freight terminal 2′ is provided in for example a particular supermarket, such that the shipper goes to the supermarket and drops off, for example, a to-be-delivered pizza as a shipment into the empty standard sized modular container 60′, which then becomes a loaded standard sized modular container 62′; in this way, the step of pre-packing the shipment into a standard sized modular container 60′ before shipping is completed. In this embodiment, the freight terminal 2′ is equipped with an image capturing device 7′ and the storing unit 20′ in the freight terminal 2′ is provided with a plurality of standard sized modular containers 60′ of different sizes for selection. Each time when the freight terminal 2′ is opened, the image capturing device 7′ will take a picture to confirm the position of the loaded standard sized modular container 62′ currently in use; moreover, a human-machine interface device such as a touch screen is provided for the freight terminal 2′, configured for the shipper to input a predetermined target as shipping information, e.g., delivery to a recipient's office building in an neighboring area. Furthermore, in order to prevent the real-time freight shipping system of the present disclosure from being used to transfer illegal shipments such as guns, the image capturing device 7′ here may further comprise for example an X-ray camera configured to scan the shipment shape for comparison and alarm.

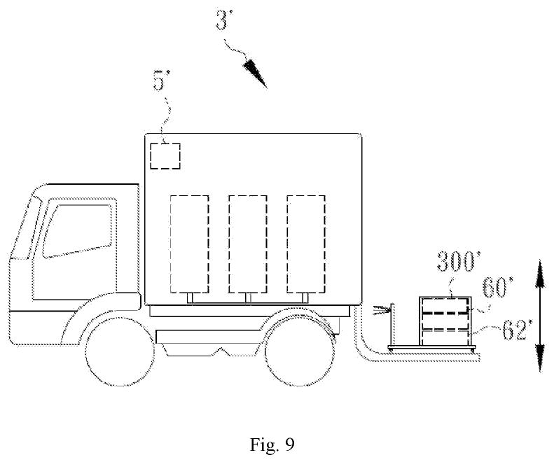

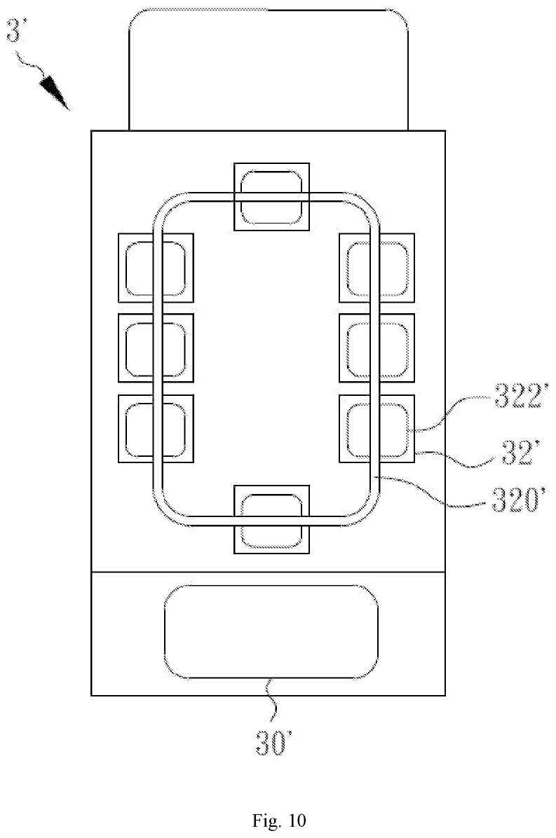

As each standard sized modular container 60′ has a unique identifier such as a standard code, the loaded standard sized modular container 62′ may be clearly identified. The freight terminal 2′ utilizes the wired network provided by the supermarket as the communication unit to transmit the shipping information to the server for computing to work out a delivery solution, and instructs the transport means 3′ and the unmanned handling unit 30′ corresponding to its operating area to come to pick up the shipment, carrying an empty standard sized modular container 60′ of the same size to the same position in the freight terminal 2′. In this embodiment, the transport means 3′ is illustrated as a truck. And as shown in FIG. 9 and FIG. 10, the truck has a specific access gate and a passageway, available for the unmanned handling unit 30′ to get off and board on; a plurality of second storing units 32′ are provided in the truck body. In this embodiment, a closed railway 320′ rotates to convey the standard slot shelf 322′ above; when the unmanned handling unit 30′ picks up the pizza loaded in the loaded standard sized modular container 62′ from the freight terminal 2′ to enter the truck body, it will be driven by the closed railway 320′ to the standard slot shelf 322′ corresponding to the operating area of the recipient's office building, causing the standard slot shelf 322′ to rotate to the position corresponding to the unmanned handling unit 30′, for securely placing the loaded standard sized modular container 62′.

The transport means 3′ is likewise provided with a wireless communication means 5′, for reporting its own position as the transit information to the server on one hand, and reporting the payload conditions in respective standard slot shelves 322′ in the truck body as payload information. During traveling of the transport means 3′, under the assistance of the closed railway 320′, the unmanned handling units 30′ constantly re-sort the standard slot shelves 322′ of respective second storing units 32′, such that those loaded standard sized modular containers 62′ to be shipped to the same or associated operating areas are sorted to the same or neighboring standard slot shelves 322′; meanwhile, based on the delivery solution provided by the server, the unmanned handling unit 30′ prepares the empty standard sized modular containers 60′ needed at the next freight terminal 2′, so as to exchange the loaded standard sized modular containers 62′ with the next freight terminal 2′, available for subsequent shippers to use. Of course, as will be easily appreciated by those skilled in the art, a communication unit is provided for the freight terminal 2′. Besides being communicatively connected with the server, the communication unit may alternatively be communicatively connected to the transport means 3′ or the unmanned handling unit 30′ for information exchange.

When the transport means 3′ arrives at the location where the operating areas are intersected, the unmanned handling unit 30′ places the empty standard sized modular container 60′ and the loaded standard sized modular container 62′, which are to be exchanged, in its own standard slots 300′, gets off from the hydraulic lifting platform at the tail of the transport means 3′, and travels to another transport means 3′ in the corresponding operating area; in this embodiment, exchange between the unmanned handling units 30′ is not performed; instead, the unmanned handling unit 30′ from the counterpart transport means 3′ enters the current vehicle to offload; after exchange of the modular containers is completed, they return to their original transport means 3′, respectively. As the whole shipping process is performed in respective intersected areas in a decentralized manner, a dedicated freight hub is unnecessary for the shipping system according to the present disclosure; instead, during traveling, all of the loaded standard sized modular containers 62′ on the transport means 3′ are first sorted and reported back to the server. In this way, even if the recipient notifies the server of changing the address of receiving the pizza to the unmanned handling unit 30′ in front of the recipient' office building where the recipient directly picks it up, the delivery solution can still be changed in real time to satisfy the recipient's demand. This may almost eliminate the odds of delivery failure, thereby improving delivery success and reducing costs.

Of course, various truck configurations and various architectures of wireless communication means in the above embodiments are not intended for limiting the present disclosure; a passenger bus in a fixed line may even be incorporated by refitting part of its space to a freight sector, while the food, for example ordered by a bus passenger, may board on the bus at the same time period as the passenger, such that the passenger off work directly picks up the food and then gets off from the bus. Besides, the step of updating the shipping information is not limited to the orders arranged in the above embodiments. Because the server has a very fast cycle in receiving and transmitting information and instructions, the updated shipping information is computed recurrently and continuously; therefore, there is no apparent sequential order between updating of the shipping information and the transport means' operating or the unmanned handling units' shipment pickup and delivery.

In view of the above, the reconfigurable decentralized shipping system and the operation method thereof save the fixed costs of establishing a freight hub and a huge number of sorting devices for the logistics service providers, saves the routes for compulsorily requiring the shipments to be sent to the hub, and reduces the amount of shipments for collective sorting; therefore, the present disclosure not only reduces errors, but also avoids falloff and damages incurred by urgent sorting; the shipments are well kept in the standard sized modular containers and securely handled by the unmanned handling unit, thereby ensuring safety and security of the shipments and preventing mistaken delivery. Particularly, the reconfigurable decentralized shipping system enables the shipper and the recipient to send and receive the shipment at their convenient time; furthermore, by real-time updating the delivery solution over the network by the computing unit, the logistics service provider may quickly and accurately deposit, pick up and transship, or real-time change the shipping destination address and arrival time, which significantly lowers the repeated delivery costs incurred by service failure, greatly enhances the efficiency of shipment pickup and delivery, and achieves a revolutionary improvement.

What is claimed is:

1. A reconfigurable decentralized freight shipping system, configured for a shipper to send at least one shipment to a predetermined target, the shipment being pre-packed into a standard sized modular container, the standard sized modular container being selected from a plurality of preset sizes, and the shipper pre-inputting shipping information including shipment information and predetermined target information to the decentralized freight shipping system; wherein when the shipper and/or the predetermined target modifies the shipping information to updated shipping information, delivery is modified in real time; wherein the decentralized freight shipping system comprises:
at least one freight terminal, including at least one first storing unit configured for storing the standard sized modular container with the shipment packed;
a plurality of transport means operating in respective operating areas, each of the operating areas being at least intersected with at least another one of the operating areas, each of the transport means including at least one unmanned handling unit, each unmanned handling unit having a plurality of standard slots, the unmanned handling unit being configured for picking up the standard sized modular container with the shipment packed, securely storing the standard sized modular container into one of the standard slots, and recording position of the standard slot;
a plurality of wireless communication means respectively installed in the plurality of transport means, the wireless communication means being configured for converting data of the respective unmanned handling unit of the plurality of transport means, loaded conditions of the respective standard slots, and position of the standard slot where the standard sized modular container with the shipment packed is stored, into updated payload information to transmit; and
at least one server storing transit information regarding the respective operating areas of the transport means and their current locations, the server being configured for receiving the shipping information and the payload information, wherein based on the received shipping information and payload information, the server computes the operating areas traversed for delivering the standard sized modular container with the shipment packed from the freight terminal to work out a delivery solution, and transmits delivery information corresponding to the delivery solution to the transport means, and when receiving the updated shipping information changed by the client and/or the predetermined target, updates the delivery solution in real time.

2. The reconfigurable decentralized freight shipping system according to claim 1, wherein each the freight terminals further comprises a communication unit configured for uploading identity data of the standard sized modular container with the shipment packed, and the position of the standard sized modular container in the freight terminal to at least one of the unmanned handling unit, the transport means, and the server.

3. The reconfigurable decentralized freight shipping system according to claim 1, wherein the transport means further comprises at least one second storing unit configured for storing the shipped standard sized modular container with the shipment packed.

4. The reconfigurable decentralized freight shipping system according to claim 1, wherein the transport means comprises at least one opening and a passageway for the unmanned handling unit to enter and exit.

5. The reconfigurable decentralized freight shipping system according to claim 1, wherein the unmanned handling unit is a dynamic balancing cart.

6. A reconfigurable decentralized freight shipping method, configured for a shipper to ship at least one shipment to a predetermined target via a reconfigurable decentralized freight shipping system, the shipment being pre-packed in a standard sized modular container, the standard sized modular container being selected from a plurality of preset sizes, the reconfigurable decentralized freight shipping system comprising: at least one freight terminal; a plurality of transport means operating in respective operating areas; a plurality of wireless communication means respectively installed in the transport means, and at least one server in communicative connection with the wireless communication means, the freight terminal including at least one storing unit configured for storing the standard sized modular container with the shipment packed; each of the operating areas being at least intersected with at least another one of the operating areas, each of the transport means including at least one unmanned handling unit, each unmanned handling unit having a plurality of standard slots, and the server storing transit information including the respective operating areas of the transport means and their current locations; wherein the reconfigurable decentralized freight shipping method comprises steps of:
a) receiving, by the server, shipping information from the shipper, wherein the shipping information includes location of the freight terminal, size of the standard sized modular container, and predetermined target data; and receiving payload information transmitted from the wireless communication means, wherein the payload information includes data regarding the respective unmanned handling units of the transport means, and loaded conditions of the respective standard slots on the respective unmanned handling units;
b) determining, by the server, a delivery solution for the standard sized modular container with the shipment packed based on the shipping information, the transit information, and the payload information;
c) transmitting, by the server via the wireless communication means, at least part of the delivery solution as delivery information to the transport means to instruct the transport means to travel to the freight terminal to pick up, via the unmanned handling unit, the standard sized modular container t with the shipment packed;
d) securely storing, by the unmanned handling unit, the standard sized modular container with the shipment packed into one of the standard slots, and recording the position of the standard slot; then, transmitting, by the wireless communication means, updated payload information to the server; and
e) in cases where the shipper and/or the predetermined target changes the shipping information to updated shipping information, updating in real-time, by the server through computing, the delivery solution based on the updated shipping information, and transmitting updated delivery information corresponding to the updated delivery solution to the transport means.

7. The reconfigurable decentralized freight shipping method according to claim 6, further comprising an exchanging step f) of instructing the transport means to exchange, with another transport means, the standard sized modular container with the shipment packed at an intersection with the neighboring operation region.

8. The reconfigurable decentralized freight shipping method according to claim 6, further comprising: a sorting step g) of sorting, by the at least one unmanned handling unit of the transport means, the standard sized modular container with the shipment packed, and changing position of the standard slot storing the standard sized modular container during travelling and/or parking period of the transport means.
